(19) United States
(12) Patent Application Publication
(10) Pub. No.: US 2003/0152183 A1
(43) Pub. Date: Aug. 14, 2003

(54) Interstellar transport vehicle engine

(76) Inventor: Peter Paul Catalasan, Harbor City, CA (US)

Correspondence Address: Peter Paul Catalasan, 25410 Dodge Ave. # K, Harbor City, CA, 90710, US

(21) Appl. No.: 10/074,934

(22) Filed: Feb. 14, 2002

(51) Int. Cl. G21J 1/00; G21B 1/00

(52) U.S. Cl. 376/100

(57) ABSTRACT

This Patent Application is a 10-year culmination of my efforts to create an interstellar transport vehicle engine, and have finally arrived at providing a new means of transportation for distances outside our known solar system. This vehicle creates matter on its own providing a foothold in space by ejecting antimatter for propulsion. However, I have gone farther than that by creating an engine that annihilates the antimatter with another generated matter for the safety of our human environment and to maximize matter-antimatter particle reactions for greater propulsion in space. With the Catalasan Nuclear Fusion Reactor coupled with two Electro-Nucleo Genesoids, this engine can travel to the far reaches of interstellar space. With all due respect, please note that this application contains dependent connections to two separate applications called the Catalasan Nuclear Fusion Reactor, a rotating centrifugal laser nuclear fusion reactor, and Electro-Nucleo Genesoids, unlimited energy by matter-antimatter production-separtation. It is highly recommended to review these two patent applications before reading this Patent Application in order to fully understand and grasp the content given here, for a fair and honest evaluation.

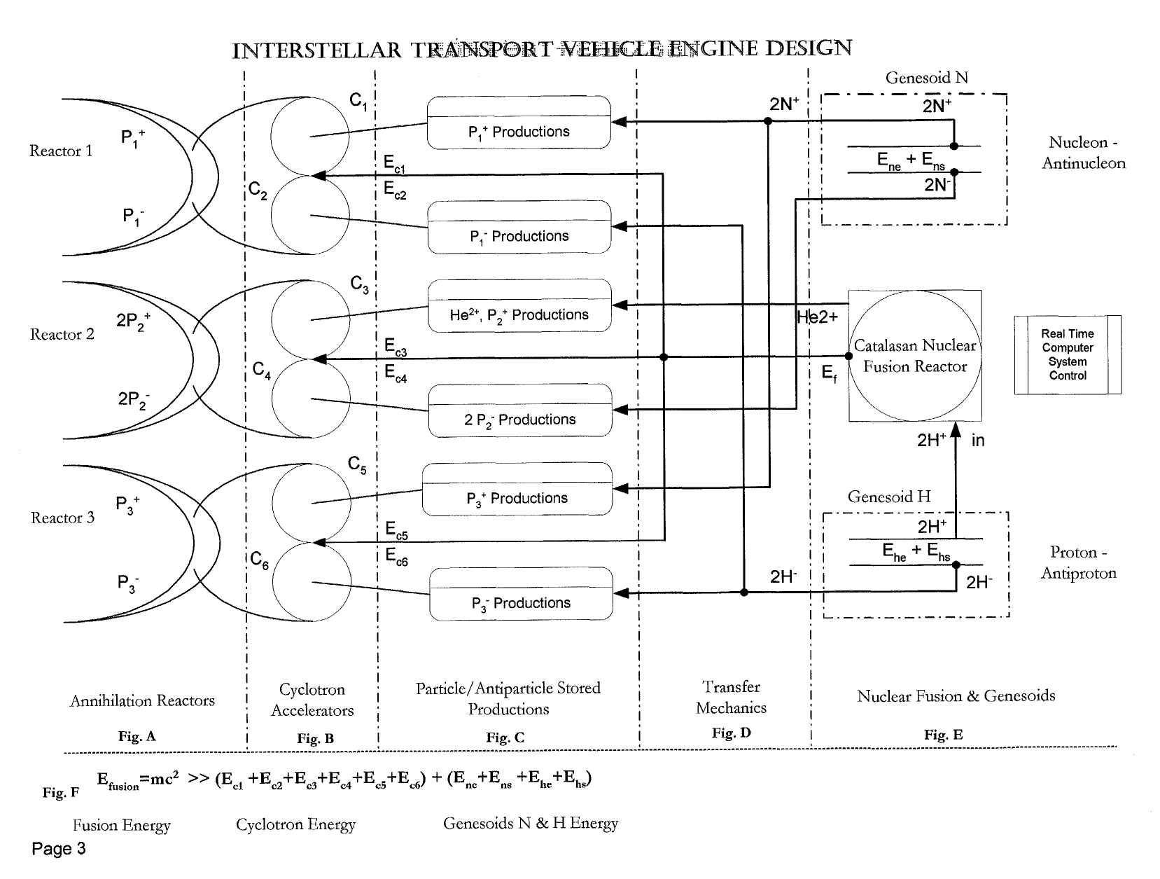

### TABLE OF CONTENTS

I. Field of Invention

II. Summary of Invention

III. System Drawings

IV. Brief Description of Drawings

V. Description of Preferred Embodiments

### I. FIELD OF INVENTION

This engine incorporates two separate Patent Applications as follows: Catalasan Nuclear Fusion Reactor, or a high-speed rotating centrifugal laser nuclear fusion reactor, and Electro-Nucleo Genesoids, unlimited energy by matter-antimatter production-separation; please refer to them for a more accurate description of their field of invention, Given Fusion and Genesoids, the remaining components for this Interstellar Transport Vehicle Engine, are particle transfer mechanics, particle storage mechanisms, cyclotron accelerators, and annihilation reactors. Thus, the needed established knowledge to understand the engine is elementary particles, material science, solid-state physics, electromagnetism, and computer guidance controls.

### II. SUMMARY OF INVENTION

Genesoids, or unlimited energy by matter/antimatter production/separation, enables the creation of matter for the purpose of using it as energy and the discharge of antimatter in space for propulsion purposes. While the Catalasan Fusion Reactor, a high-speed rotating centrifugal laser nuclear fusion reactor, harnesses the power of nuclear energies for the conversion of the generated matter into energy. Next, the particle-antiparticle productions from the genesoids are stored in theoretical containers not yet physically described, where after then, the particles are fed into a cyclotron to be accelerated into the annihilation reactors for propulsion purposes.

### SYSTEM DRAWINGS

Please see drawing page.

### III. BRIEF DESCRIPTION OF DRAWINGS

FIG. F deals with the concept of the Total Energy of the entire system such that the Fusion Energy released, E_{f}, of the Catalasan Nuclear Fusion Reactor, is so much greater than the Energy of the Genesoids (matter-antimatter production and separation and enticement), and Energy of the Cyclotron Accelerators. The reason why this is possible is that nuclear energy releases are greater than electromagnetic creation and confinement energies of the Genesoids and Fusion of the system even if the fusion reaction only releases part of its E=mc². In other words, E_{f}=mc²>>(E_{c1}+E_{C2}+E_{C3}+E_{C4}+E_{C5}+E_{C6})+(Eₙₑ+Eₙₛ+Eₕₑ+Eₕₛ).

FIG. E consists of a Pair of Genesoids that generate matter and antimatter and complement each other so that they annihilate together with the Helium that is produced from the fusion output reactor in order to accommodate the safety of human environments; i e., antimatter when released to ordinary matter annihilates and will explode on contact.

The next is the Catalasan Fusion Reactor, specified through another Patent Application but will mention the basics here as a Black Box approach The incoming Input is the Two Protons, 2H⁺, generated by Genesoid H. The Output is the Helium matter, He²⁺, which will also be annihilated after it is stored in the He²⁺ Stored Productions in FIG. C. Moreover, the Output Fusion Energy, E_{f}, is used in the process of the acceleration of the particles and antiparticles (Cyclotron, FIG. B) into the Annihilation Reactors, FIG. A.

### IV. DESCRIPTION OF THE PREFERRED EMBODIMENTS

The Total Energy of the System, FIG. F, which consists the Catalasan Nuclear Fusion Energy, E_{f}=mc², the Cyclotron Accelerator Energies, E_{c1}+E_{c2}+E_{c3}+E_{c4}+E_{c5}+E_{c6}, the Genesoid H Energy, Eₙₑ, nucleon enticement energy and, Eₙₛ, nucleon electromagnetic separation energy, and Genesoid N Energy, Eₕₑ, hydrogen enticement energy and, Eₕₛ, hydrogen electromagnetic separation energy, results in positive energy gains due to Genesoids' unlimited energy by matter-antimatter production-separation even if the fusion energy, E_{f}=mc², releases partial energy in the fusion process. In other words, E_{f}=mc²>>(E_{c1}+E_{c2}+E_{c3}+E_{c4}+E_{c5}+E_{c6})+(Eₙₑ+Eₙₛ+Eₕₑ+Eₕₛ).

The Catalasan Nuclear Fusion Reactor, FIG. E, is a separate Patent Application entitled “Catalasan Nuclear Fusion Reactor,” which is a rotating centrifugal laser nuclear fusion reactor.

The Two Genesoids H & N, FIG. E, is a separate Patent Application entitled “Electro-Nucleo Genesoids,” which is unlimited energy by matter-antimatter production and separation.

The Real Time Computer System, FIG. E, consists of microprocessors that regulate the behavior of the Interstellar Transport Vehicle Engine governed by Artificial Intelligence and Human Pilot control.

The Transfer Mechanics, FIG. D, is basically a Criss-Cross of the Genesoid creation of matter and antimatter such that particles will annihilate with antiparticles and antiparticles with particles, and including the Catalasan Nuclear Fusion output product, He²⁺! The two nucleons, 2N⁺, created from the Genesoid N splits and enters into the P₁⁺ Productions and the P₃⁺ Productions, which are particle and antiparticle electromagnetic confinement storage. The two hydrogen anti-protons, 2H⁻, created from the Genesoid H also splits and enters into the P₁⁻ Productions and the P₃⁻ Productions, which are particle and antiparticle electromagnetic confinement storage. Then, the two anti-nucleons, 2N⁻, created from Genesoid N enter into the 2P₂⁻ Productions in order to annihilate the fusion Helium output, He²⁺, which enters into the He²⁺ P₂⁺ Productions And, the two hydrogen protons, 2H⁺, created from the Genesoid H enter the Catalasan Nuclear Fusion Reactor. Finally, the Fusion Energy, E_{f}, produced, transfers the energy into accelerating particles and antiparticles, E_{c1}+E_{c2}+E_{c3}+E_{c4}+E_{c5}+E_{c6}.

The Particle & Antiparticle Stored Productions, FIG. C, are special containers for the storage of particles and antiparticles waiting to be accelerated by the Cyclotron Accelerators, FIG. B. The containers require that particles and antiparticles do not have contact with the container material, in essence, electromagnetic fields, which may require little energy not shown in the Drawing, being the magnitude very low.

The Cyclotron Accelerators, FIG. B: C₁, C₂, C₃, C₄, C₅, C₆, accelerate particles and antiparticles to the Annihilation Reactors, 1, 2, and 3, FIG. A.

The Annihilation Reactors, FIG. A, require that the particles and antiparticles annihilate to produce maximum energy and mass release in order to propel the vehicle in space Since, for every action there is an opposite and equal reaction, the Interstellar Transport Vehicle Engine will accelerate to the far reaches of Interstellar Space.

Theoretically, since by the Genesoid's creation of matter on its own to be used for energy and to expel the antimatter, this system can accelerate continuously for all time! According to Einstein, nothing can travel faster than the speed of light because near the speed of light the mass becomes so heavy that nothing can push it past the, so-called, Light Barrier.

However recently, a German scientist was able to travel photons faster than the speed of light through Quantum Tunneling.

My point is that this engine, I believe can travel faster than the speed of light because it can accelerate indefinitely, leading to time reversals, since past the speed of light time becomes negative. Having this knowledge, we can apply this Interstellar Transport Vehicle Engine to overcome long distances through the use of Einstein 's properties of Relativity upon which many equations have negative time dependency related to the speed of light. For example, if it takes one million light-years to get to another Galaxy, why not go back in time for one million light-years while traveling there, therefore arriving at t=0.

1. Time Machine

2. Solar, Extra Solar, and Interstellar Space Transport Vehicle Engine

3. Interstellar Artificial Intelligence Guided Probe
